(19) United States
(12) Patent Application Publication
(10) Pub. No.: US 2025/0294480 A1
(43) Pub. Date: Sep. 18, 2025

(54) ENHANCED SYNCHRONINIZATION SIGNALS FOR A WIRELESS COMMUNICATIONS SYSTEM

(71) Applicant: Lenovo (United States) Inc., Morrisvile, NC (US)

(72) Inventor: Vijay NANGIA, Woodridge, IL (US)

(21) Appl. No.: 19/221,276

(22) Filed: May 28, 2025

(51) Int. Cl. H04W 56/00; H04W 72/30

(52) U.S. Cl. CPC H04W 56/001; H04W 72/30

(57) ABSTRACT

Various aspects of the present disclosure relate to synchronization signal designs, such as enhanced primary synchronization signals (PSSs) or secondary synchronization signals (SSSs) associated with different radio access technologies (RATs). For example, a synchronization signal may include a first PSS on a first set of resources and/or a second PSS on a second set of resources that partially overlap the first set of resources, where the first PSS is based on a first m-sequence and the second PSS is based on a second m-sequence that is a preferred pair with the first m-sequence. Thus, a wireless communications system may introduce, support, and/or deploy synchronization signals that enables UEs, regardless of their supported RAT capabilities, to identify a RAT/cell and/or perform initial access communications (e.g., transmission and/or reception) with an identified RAT/cell.

### TECHNICAL FIELD

The present disclosure relates to wireless communications, and more specifically to enhanced designs of synchronization signals.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that provide and/or support enhanced synchronization signal designs.

A UE for wireless communication is described. The UE may be configured to, capable of, or operable to perform one or more operations as described herein. For example, the UE may comprise at least one memory and at least one processor coupled with the at least one memory and configured to cause the UE to receive, from a network node, a synchronization signal that includes a first primary synchronization signal (PSS) on a first set of resources or a second PSS on a second set of resources that partially overlap the first set of resources, wherein the first PSS is based on a first m-sequence and the second PSS is based on a second m-sequence that is a preferred pair with the first m-sequence, and communicate with the network node based on a PSS included in the synchronization signal.

A method performed or performable by the UE is described. The method may comprise receiving, from a network node, a synchronization signal that includes a first PSS on a first set of resources or a second PSS on a second set of resources that partially overlap the first set of resources, wherein the first PSS is based on a first m-sequence and the second PSS is based on a second m-sequence that is a preferred pair with the first m-sequence, and communicating with the network node based on a PSS included in the synchronization signal.

In some implementations of the UE and method described herein, the first PSS is associated with a first radio access technology (RAT) and the second PSS is associated with a second RAT, the UE and method may further be configured to, capable of, performed, performable, or operable to determine whether the synchronization signal is received from the first RAT or the second RAT based on the PSS included in the synchronization signal and communicate via a RAT associated with the PSS included in the synchronization signal.

In some implementations of the UE and method described herein, the second m-sequence is different from the first m-sequence.

In some implementations of the UE and method described herein, a secondary synchronization signal (SSS) is associated with the first RAT based on the first m-sequence and the second m-sequence.

In some implementations of the UE and method described herein, the first PSS is located in a first predefined synchronization signal raster in a frequency domain in a frequency band and the second PSS is located in a second predefined synchronization signal raster, different that the first predefined synchronization signal raster, in the frequency domain in the frequency band.

In some implementations of the UE and method described herein, the UE and method may further be configured to, capable of, performed, performable, or operable to determine at least a portion of a physical layer cell identity for the network node based on the determined PSS and communicate with the network node based on the portion of the physical layer cell identity.

In some implementations of the UE and method described herein, the first m-sequence and the second m-sequence are elements of a maximal connected set of m-sequences having lengths equal to a length of the first m-sequence.

In some implementations of the UE and method described herein, the first PSS is based on a first set of cyclic shifts of the first m-sequence and the second PSS is based on a second set of cyclic shifts of the second m-sequence.

In some implementations of the UE and method described herein, the second set of cyclic shifts is different than all elements of the first set of cyclic shifts.

In some implementations of the UE and method described herein, the first set of cyclic shifts and the second set of cyclic shifts are based on a portion of a physical layer cell identity for the network node.

In some implementations of the UE and method described herein, the first m-sequence is based on first non-zero initial values of a first linear feedback shift register generator and the second m-sequence is based on second non-zero initial values of a second linear feedback shift register generator.

In some implementations of the UE and method described herein, the first m-sequence is based on a first recursive equation and the second m-sequence based on a second recursive equation.

In some implementations of the UE and method described herein, the first PSS is based on a first set of cyclic shifts of the first m-sequence and the second PSS is based on a second set of cyclic shifts of the first m-sequence that is different than the first set of cyclic shifts.

In some implementations of the UE and method described herein, the first PSS is associated with a first power and the second PSS is associated with a second power.

In some implementations of the UE and method described herein, a first physical broadcast channel (PBCH) is associated with the first PSS and a second PBCH is associated with the second PSS, wherein the second PBCH has a different size, fields, field values, or time-frequency values than the first PBCH, and the UE and method may further be configured to, capable of, performed, performable, or operable to receive the first PBCH or the second PBCH based on the PSS included in the synchronization signal.

A network node for wireless communication is described. The network node may be configured to, capable of, or operable to perform one or more operations as described herein. For example, the network node may comprise at least one memory and at least one processor coupled with the at least one memory and configured to cause the network node to transmit, to a UE, a synchronization signal that includes a first PSS on a first set of resources or a second PSS on a second set of resources that partially overlap the first set of resources, wherein the first PSS is based on a first m-sequence and the second PSS is based on a second m-sequence that is a preferred pair with the first m-sequence; and receive a transmission from the UE based on a PSS included in the synchronization signal.

A method performed or performable by the network node is described. The method may comprise transmitting, to a UE, a synchronization signal that includes a first PSS on a first set of resources or a second PSS on a second set of resources that partially overlap the first set of resources, wherein the first PSS is based on a first m-sequence and the second PSS is based on a second m-sequence that is a preferred pair with the first m-sequence; and receiving a transmission from the UE based on a PSS included in the synchronization signal.

A UE for wireless communication is described. The UE may be configured to, capable of, or operable to perform one or more operations as described herein. For example, the UE may comprise at least one memory and at least one processor coupled with the at least one memory and configured to cause the UE to receive, from a network node, a synchronization signal that includes a first SSS on a first set of resources or a second SSS on a second set of resources that partially overlap the first set of resources, wherein the first SSS is based on a first m-sequence and a second m-sequence that is a first preferred pair with the first m-sequence, and the second SSS is based on a third m-sequence and a fourth m-sequence that is a second preferred pair with the third m-sequence, and communicate with the network node based on an SSS included in the synchronization signal.

A method performed or performable by the UE is described. The method may comprise receiving, from a network node, a synchronization signal that includes a first SSS on a first set of resources or a second SSS on a second set of resources that partially overlap the first set of resources, wherein the first SSS is based on a first m-sequence and a second m-sequence that is a first preferred pair with the first m-sequence, and the second SSS is based on a third m-sequence and a fourth m-sequence that is a second preferred pair with the third m-sequence, and communicating with the network node based on an SSS included in the synchronization signal.

In some implementations of the UE and method described herein, the first preferred pair and the second preferred pair are elements of a connected set of m-sequences having a shared length with a length of the first m-sequence.

In some implementations of the UE and method described herein, the third m-sequence is a reciprocal of the first m-sequence, or the fourth m-sequence is a reciprocal of the second m-sequence.

In some implementations of the UE and method described herein, the first m-sequence is a same m-sequence as the third m-sequence, and wherein a first set of cyclic shifts of the first m-sequence is different than a third set of cyclic shifts of the third m-sequence.

In some implementations of the UE and method described herein, the third set of cyclic shifts is offset by a constant from the first set of cyclic shifts.

In some implementations of the UE and method described herein, a second set of cyclic shifts of the second m-sequence is a same set as a fourth set of cyclic shifts of the fourth m-sequence, and wherein the second set of cyclic shifts and the fourth set of cyclic shifts are based on a first portion of a physical layer cell identity of the network node.

In some implementations of the UE and method described herein, the first set of cyclic shifts and the third set of cyclic shifts are based on a first portion and a second portion of a physical layer cell identity of the network node, and the UE and method may further be configured to, capable of, performed, performable, or operable to determine the first portion or the second portion of the physical layer cell identity of the network node based on the SSS included in the synchronization signal and communicate with the network node based on the first portion or the second portion of the physical layer cell identity.

In some implementations of the UE and method described herein, the first SSS is associated with a first RAT and the second SSS is associated with a second RAT, and the UE and method may further be configured to, capable of, performed, performable, or operable to determine whether the synchronization signal is received from the first RAT or the second RAT based on the SSS included in the synchronization signal and communicate via a RAT associated with the SSS included in the synchronization signal.

In some implementations of the UE and method described herein, a PSS is associated with the first RAT based on the first m-sequence.

In some implementations of the UE and method described herein, a first PSS is associated with the first RAT based on the first m-sequence and a second PSS is associated with the second RAT based on the second m-sequence.

In some implementations of the UE and method described herein, third m-sequence is a same sequence as the first m-sequence and the fourth m-sequence is a same sequence as the second m-sequence.

In some implementations of the UE and method described herein, first PSS is based on a fifth set of cyclic shifts of the first m-sequence and the second PSS is based on a sixth set of cyclic shifts of the second m-sequence, wherein at least one element of the fifth set of cyclic shifts is different than all elements of the sixth set of cyclic shifts, and wherein the fifth set of cyclic shifts and the sixth set of cyclic shifts are based on a physical layer cell identity of the network node.

In some implementations of the UE and method described herein, the first SSS is located in a first predefined synchronization signal raster in a frequency domain in a frequency band and the second SSS is located in a second predefined synchronization signal raster, different that the first predefined synchronization signal raster, in the frequency domain in the frequency band.

In some implementations of the UE and method described herein, the first m-sequence is based on a first recursive equation and the second m-sequence based on a second recursive equation.

In some implementations of the UE and method described herein, the first SSS is associated with a first power and the second SSS is associated with a second power.

In some implementations of the UE and method described herein, a first PBCH is associated with the first SSS and a second PBCH is associated with the second SSS, wherein the second PBCH has a different size, fields, field values, or time-frequency values than then first PBCH, and the UE and method may further be configured to, capable of, performed, performable, or operable to receive the first PBCH or the second PBCH based on the SSS included in the synchronization signal.

A network node for wireless communication is described. The network node may be configured to, capable of, or operable to perform one or more operations as described herein. For example, the network node may comprise at least one memory and at least one processor coupled with the at least one memory and configured to cause the network node to transmit, to a UE, a synchronization signal that includes a first SSS on a first set of resources or a second SSS on a second set of resources that partially overlap the first set of resources, wherein the first SSS is based on a first m-sequence and a second m-sequence that is a first preferred pair with the first m-sequence and the second SSS is based on a third m-sequence and a fourth m-sequence that is a second preferred pair with the third m-sequence, and receive a transmission from the UE based on an SSS included in the synchronization signal.

A method performed or performable by the network node is described. The method may comprise transmitting, to a UE, a synchronization signal that includes a first SSS on a first set of resources or a second SSS on a second set of resources that partially overlap the first set of resources, wherein the first SSS is based on a first m-sequence and a second m-sequence that is a first preferred pair with the first m-sequence and the second SSS is based on a third m-sequence and a fourth m-sequence that is a second preferred pair with the third m-sequence, and receiving a transmission from the UE based on an SSS included in the synchronization signal.

### BRIEF DESCRIPTION OF THE DRAWINGS

FIG. 1 illustrates an example of a wireless communications system in accordance with aspects of the present disclosure.

FIG. 2 illustrates an example m-sequence generator in accordance with aspects of the present disclosure.

FIG. 3 illustrates example preferred pairs of m-sequences in accordance with aspects of the present disclosure.

FIG. 4 illustrates an example graph of cross-correlation magnitudes for m-sequences in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

FIG. 10 illustrates a flowchart of a method performed by a UE in accordance with aspects of the present disclosure.

FIG. 11 illustrates a flowchart of a method performed by an NE in accordance with aspects of the present disclosure.

### DETAILED DESCRIPTION

The present disclosure relates to methods, apparatuses, and systems that provide, support, implement, and/or introduce new or enhanced designs of synchronization signals, such as PSS designs and/or SSS designs.

As radio access technologies (RATs) progress (e.g., from 5G to 6G), a wireless communications system may maintain and operate, in parallel, multiple RATs (e.g., 4G, 5G, and 6G) for a relatively long period of time, to ensure continuity in services for various user devices that support some, but not all, of the RATs (e.g., some UEs may support a legacy RAT, while others may support a new RAT). The wireless communications system, therefore, may implement efficient mechanisms to deploy communications resources in a same spectrum for the different RATs to ensure an overall spectrum capacity is dynamically shared between different RATs.

However, to ensure an optimized dynamic spectrum sharing across RATs, the wireless communications system may seek continued improvement in spectral efficiency, such as a minimization of resources (e.g., deployed for new RAT access) that may be unused or not accessible by certain user devices (e.g., legacy UEs).

The present disclosure introduces a synchronization signal design, for a new RAT (e.g., 6G), that may be deployed via time-frequency resources for the new RAT while co-existing with time-frequency resources for legacy RATs. The new or enhanced design of the synchronization signals (e.g., PSS and/or SSS) may enable an early or initial RAT identification (e.g., for a UE that supports the new RAT and is seeking access to the new RAT). Further, the new or enhanced design may facilitate the support of large (or relatively larger) numbers of cells (e.g., a number of unique physical-layer cell identities that is greater than the 1008 cell IDs supported by 5G).

For example, a synchronization signal may include a first PSS on a first set of resources and/or a second PSS on a second set of resources that partially overlap the first set of resources, where the first PSS is based on a first m-sequence and the second PSS is based on a second m-sequence that is a preferred pair with the first m-sequence. As another example, the synchronization signal may include a first SSS on a first set of resources and/or a second SSS on a second set of resources that partially overlap the first set of resources, where the first SSS is based on a first m-sequence and a second m-sequence that is a first preferred pair with the first m-sequence and the second SSS is based on a third m-sequence and a fourth m-sequence that is a second preferred pair with the third m-sequence.

Thus, the wireless communications system may introduce, support, and/or deploy synchronization signals that enables UEs, regardless of their supported RAT capabilities, to identify a RAT/cell and/or perform initial access communications (e.g., transmission and/or reception) with an identified RAT/cell. In doing so, the system may minimize deployment or use of resources that may be unusable for different types of UEs, improving the efficiency and performance of a wireless network, among other benefits.

Aspects of the present disclosure are described in the context of a wireless communications system.

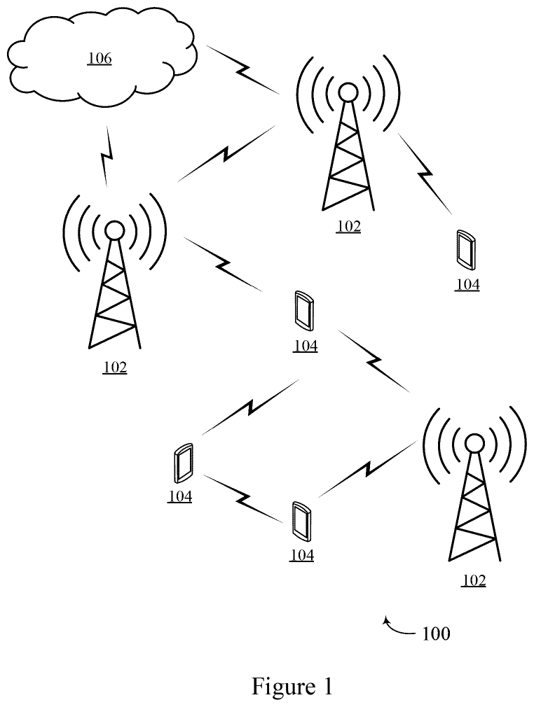

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz—7.125 GHz), FR2 or FR2-1 (24.25 GHz-52.6 GHz), FR3 (7.125 GHz −24.25 GHz), FR4 (52.6 GHz-114.25 GHz), FR4a or FR4-1 or FR2-2 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some examples, an initial access functionality comprises a pair of downlink signals, the PSS and SSS, used by the UE 104 to find, synchronize to, and/or identify the NE 102. The PSS and SSS may each occupy 1 symbol and 127 subcarriers. The UE 104 may determine the cell identity from the PSS and/or SSS. When the UE 104 is performing initial cell search, the UE 104 may search first for the PSS. The PSS may be in a predefined synchronization signal raster in the frequency domain. The PSS may be used for an initial symbol boundary and coarse frequency synchronization to an NR cell (e.g., even though the UE 104 searches for a cell at a given carrier frequency, there may be a relatively large deviation between the UE 104 and the NE 102 carrier frequency due to inaccuracy of the device internal frequency reference of the UE 104).

Once UE 104 has detected a PSS, the UE 104 may determine the transmission timing of the SSS. The SSS may be located on the same frequency location as the PSS (e.g., one OFDM symbol apart), and the UE 104 may perform either non-coherent or coherent detection using channel estimates based on the PSS. Since the timing of the SSS is known to the UE 104, the per-sequence search complexity may be reduced with respect to the PSS, enabling a greater number of SSS sequences. By detecting the SSS, the UE 104 can determine the Physical-layer Cell Identity (PCID) of the detected cell (e.g., the NE 102).

In some examples, a downlink PBCH is transmitted together with the PSS/SSS. The PBCH carries a minimum amount of system information, including an indication where the remaining broadcast system information is transmitted. The PSS, SSS, and PBCH may be jointly referred to as a synchronization signal block (SSB) or SS/PBCH block. The SSB may be transmitted once every 20 ms. Due to a longer period between consecutive SS blocks, the UE 104, searching for a carrier, may dwell on each possible frequency for a longer time. To reduce the overall search time, a sparse frequency raster for the SS block may be used. Thus, the possible frequency-domain positions of the SS block may be significantly sparser compared to the possible positions of a carrier (e.g., the carrier raster). As a result, the SS block may not be located at the center of the carrier. In some examples, the SSB bandwidth may be 20 RBs, where an RB comprises 12 subcarriers in a frequency. In the time domain, an SS/PBCH block may include multiple OFDM symbols (e.g., 4 OFDM symbols numbered in increasing order from 0 to 3 within the SS/PBCH block) where the PSS, SSS, and PBCH with associated DM-RS (demodulation reference signals) are mapped to symbols 0, 2, and set of 1, 2, 3 symbols, respectively. In the frequency domain, an SS/PBCH block may include 240 contiguous subcarriers with length—127 PSS and length—127 SSS mapped to 127 subcarriers within the center 12 RBs with guard subcarriers near the edges.

As described herein, the technology provides and/or introduces a synchronization signal design for a new RAT (e.g., 6G), which may be deployed via time-frequency resources associated with the new RAT while co-existing with time-frequency resources for legacy RATs. For example, to facilitate an efficient spectrum sharing between a first RAT (e.g., 5G/NR) and a second RAT (e.g., 6G), both operating in a first frequency band, one or more of the PSS, SSS, PBCH, and/or synchronization signal block (SSB) of the second RAT may occupy at least a portion of time-frequency resources used for a corresponding PSS, SSS, PBCH, and/or SSB transmission of the first RAT.

The UE 104 may communicate with the NE 102 via the PSS, SSS, PBCH, and/or SSB transmissions or communications (e.g., by performing reception and/or transmission facilitated by the PSS/SSS designs described herein). Thus, in some examples, a network node (e.g., the NE 102) may perform a transmission to the UE based on a PSS and/or an SSS included in the synchronization signal.

In some examples, one or more of the PSS, SSS, PBCH, and/or SSB of the second RAT may occupy a same time-frequency resource and bandwidth with a corresponding PSS, SSS, PBCH, and/or SSB transmission for the first RAT. In some cases, the first RAT and the second RAT may have the same subcarrier spacing (SCS). In some cases, there may be no reserved or unused resources on the second RAT that correspond to the PSS, SSS, PBCH, and/or SSB transmission for the first RAT.

In some examples, a network node, such as a base station or other NE 102, operating in the first frequency band, may transmit the one or more PSS, SSS, PBCH, and/or SSB of the first RAT and/or the one or more PSS, SSS, PBCH, and/or SSB of the second RAT on the time-frequency resources. For example, the network node may transmit the PSS, SSS, PBCH, and/or SSB of the first RAT with a first transmit power and the PSS, SSS, PBCH, and/or SSB of the second RAT with a second transmit power (e.g., different than the first transmit power) on a (partially) overlapping time-frequency resource.

As described herein, the PSS/SSS of one RAT (e.g., a legacy RAT) may be cross-correlated (e.g., exhibiting a good cross-correlation) with the PSS/SSS of a second RAT (e.g., a 6G RAT), such as the signals may co-exist on the same frequency resources. For example, when the UE 104 (e.g., a user device that receives the PSS/SSS or other signals or channels) only supports a RAT (e.g., the legacy RAT), the UE 104 is not affected by the PSS/SSS of the 6G RAT and the impact of its cell search or detection of the PSS/SSS of the new RAT is not affected due to the cross-correlation.

As another example, when the UE 104 supports both RATs (e.g., the new RAT and a legacy RAT), the UE 104 may search for and detect the PSS/SSS from either RAT and identify or determine the RAT based on the detected PSS/SSS. The UE 104, using the determined RAT, may perform an early identification of the RAT during an initial cell search and/or access/synchronization procedure.

In some cases, the UE 104 may identify the RAT based on a format, contents, and/or time-frequency resources that occupy subsequent signals/channels (e.g., after PSS/SSS detection) being different between the different RATs. For example, PBCH size, contents, and/or resources in the second RAT may be different from the corresponding the PBCH size, contents, and/or resources in the first RAT. As another example, the PSS of the second RAT is different (e.g., with good cross-correlation properties) than the PSS of the first RAT PSS, while the SSS of the second RAT is the same as the SSS of the first RAT.

In some examples, the synchronization signals (e.g., PSS, SSS, SSB) of the first RAT may located in a first predefined synchronization signal raster in a frequency domain, and the synchronization signals (e.g., PSS, SSS, SSB) of the second RAT may located in a second predefined synchronization signal raster in the frequency domain, where the first synchronization signal raster is different than the second synchronization signal raster. In some cases, the synchronization signals of the first RAT may be associated with a first set of global synchronization channel numbers (GSCNs) and the synchronization signals of the second RAT may be associated with a second set of GSCNs.

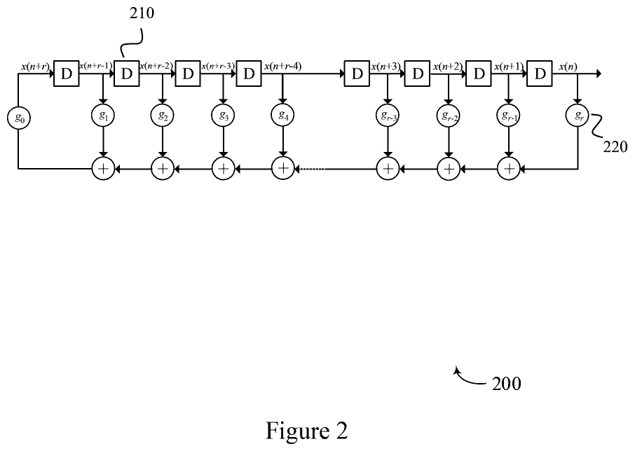

As described herein, in some embodiments, the PSS and/or SSS is based on an m-sequence. An m-sequence (e.g., a maximum-length sequence) may be a pseudo-random binary sequence generated using a maximal linear feedback shift register with a maximum possible period of 2^{r-1} for an r-stage shift register. FIG. 2 illustrates an example m-sequence generator 200 in accordance with aspects of the present disclosure.

Each different non-zero initial condition (e.g., x(r−1), x(r−2), x(r−3) . . . x(3), x(2), x(1), x(0)), or non-zero state, of an r-stage shift register 210 generates a different phase of a same m-sequence as the shift register 210 cycles through all possible non-zero states. For example, a binary primitive generator polynomial g(X)=Σₖ₌₀^{r}gₖ·X^{k}, over GF(2), a Galois Field of size 2 comprising two elements, 0 and 1), is associated with the linear feedback shift register 210. The degree of the polynomial may be equal to the length r of the r-stage shift register 210 and the coefficients 220 (e.g., gₖ∈{0, 1}) are either 0 or 1 correspond to taps of the shift register 210. A binary coefficients vector [gᵣ, gᵣ₋₁, gᵣ₋₂, . . . g₂, g₁, g₀] may be determined in a concise from as an octal number, which gives the coefficients 220 beginning with g₀ on the right and proceeding to gᵣ in a last non-zero position on the left.

### Examples of a PSS Design

As described herein, in some examples, a PSS for the first RAT (e.g., the legacy RAT, such as for 5G) may be constructed from a binary m-sequence x(n) of length N=2^{r-1} generated by via a generator polynomial of degree r=7 using a primitive (over GF(2)) polynomial g(X)=X⁷+X³+, with a coefficients vector
[g₇ g₆ g₅ g₄ g₃ g₂ g₁ g₀]=1 1 0 0 0 1 0 0 1] (g₀ on right to gᵣ on left), which is [211] in octal representation. Each octal digit (0, 1, . . . , 7) may be represented by a group of three binary digits (000, 001, 010, 011, 100, 101, 110, 111), respectively.

The initial condition is [x(6) x(5) x(4) x(3) x(2) x(1) x(0)]=[1 1 1 0 1 1 0] with a recursive definition of subsequent sequence elements may be described as:

$$x ( i + 7 ) = ( x ( i + 4 ) + x ( i ) ) mod 2$$

The sequence d_{PSS}(n) for the NR primary synchronization signal may be defined by different cyclic shifts [0, 43, 86] of the m-sequence based on the value of N (according to:

$${d}_{PSS} ( n ) = 1 - 2 x ( m )$$

$$m = ( n + 43 {N}_{ID}^{( 2 )} ) mod 127$$

$$0 \leq n < 127$$

For the second RAT (e.g., a new RAT, such as for 6G), the PSS sequence may be based on the same length—127 m-sequence as the PSS for the first RAT but with different cyclic shift values. For example, the cyclic shift values of the PSS for the second RAT may be based on an offset from the cyclic shifts on the PSS of the first RAT and based on the value of N_{ID}⁽²⁾ (e.g., an offset of 22 resulting in cyclic shifts [22, 55, 98]). Thus, the sequence d′_{PSS}(n) for the PSS of the second RAT can be defined by:

$${d}_{PSS}^{′} ( n ) = 1 - 2 x ( m )$$

$$m = ( n + 22 + 43 {N}_{ID}^{( 2 )} ) mod 127$$

$$0 \leq n < 127$$

$$Where :$$

$$x ( i + 7 ) = ( x ( i + 4 ) + x ( i ) ) mod 2$$

and initial condition/values are:
[x(6) x(5) x(4) x(3) x(2) x(1) x(0)]=[1 1 1 0 1 1 0]

As another example, the PSS (or PSS sequence) for the new RAT may be based on a different (e.g., second) length—127 m-sequence than the first m-sequence used in the PSS of the first RAT (e.g., the legacy RAT). In some cases, the selection of the second m-sequence may be based on a good (e.g., low) cross-correlation between the first m-sequence and the second m-sequence. Thus, selections for the second m-sequence may be sequences that have or exhibit good (e.g., low) cross-correlation properties with the first m-sequence.

The full-period cross-correlation between two m-sequences may be defined as:

$${θ}_{{dd}^{′}} ( k ) = \frac{1}{N} {\sum }_{n = 0}^{N - 1} d ( n ) \cdot {d}^{′} ( n - k )$$

For example, a cross-correlation spectrum is a list of all possible values of θ_{bb′}(k) and the number of values of k that yield a particular or target cross-correlation. The cross-correlation spectrum of pairs of m-sequences may be three-valued, four-valued, or possibly many-valued. For example, there are certain special pairs of m-sequences called preferred pairs. In some cases, preferred pairs of m-sequences have a cross-correlation spectrum that is three-valued, where those three values are:

$$- \frac{1}{N} t ( n ) , - \frac{1}{N} , \frac{1}{N} [ t ( n ) - 2 ]$$

$$Where :$$

$$t ( n ) = \{ \begin{matrix}1 + {2}^{0.5 ( n + 1 )} & for n odd \\ 1 + {2}^{0.5 ( n + 2 )} & for n even\end{matrix}$$

and where the m-sequence has a period or length N=2ⁿ−1. Thus, in some examples, a preferred pair x and x′ of m-sequences may satisfy the following conditions: (1) n≠0 mod 4 i.e., n is odd or n≠2 mod 4, (2) x′=x[q]i.e., x′ is obtained by sampling or decimating every q^{th} element of x, where q is odd and either q=2^{k}+1 or q=2^{2k}−2^{k}+1, and

$$g c d ( n , k ) = \{ \begin{matrix}1 & for n odd \\ 2 & for n = 2 mod 4\end{matrix} . \qquad ( 3 )$$

In some cases, a pair of primitive polynomials that generate a preferred pair of m-sequences is called a preferred pair of polynomials. As a polynomial is used to generate a m-sequence, the preferred pairs of m-sequences and preferred pair of polynomials may be used interchangeably. A set (or a group) of m-sequences that has a property of each pair in the set being a preferred pair of m-sequences is called a connected set of m-sequences, where a largest possible connected set is called a maximal connected set.

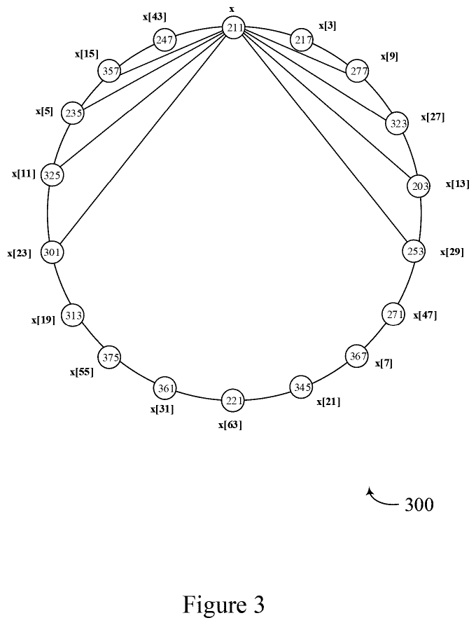

FIG. 3 illustrates example preferred pairs of m-sequences 300 in accordance with aspects of the present disclosure. As an example, for N=127, there are eighteen m-sequences with a generator polynomial in octal representation, where every set of six consecutive vertices is a maximal connected set. Given an initial condition of [x(6) x(5) x(4) x(3) x(2) x(1) x(0)], the recursive definition of the subsequent sequence elements described for the eighteen m-sequences are as given in Table 1, below. For example, the polynomials [211], [301], [203], [221] correspond to the linear feedback shift-register 210 of FIG. 2, with only two feedback connections.

TABLE 1
Octal representation and recursive equation of generator
polynomial for eighteen length-127 m-sequences.

| Octal | |
|---|---|
| representation | Recursive equation |
| of Generator | with non-zero initial condition of: |
| polynomial | [x(6) x(5) x(4) x(3) x(2) x(1) x(0)] |
| 211 | x(i + 7) = (x(i + 4) + x(i)) mod 2 |
| 247 | x(i + 7) = (x(i + 6) + x(i + 5) + x(i + 2) + x(i)) mod 2 |
| 357 | x(i + 7) = (x(i + 6) + x(i + 5) + + x(i + 4) + x(i + 2) + x(i + 1) + x(i)) mod 2 |
| 235 | x(i + 7) = (x(i + 5) + x(i + 4) + x(i + 3) + x(i)) mod 2 |
| 325 | x(i + 7) = (x(i + 5) + x(i + 3) + x(i + 1) + x(i)) mod 2 |
| 301 | x(i + 7) = (x(i + 1) + x(i)) mod 2 |
| 313 | x(i + 7) = (x(i + 6) + x(i + 4) + x(i + 1) + x(i)) mod 2 |
| 375 | x(i + 7) = (x(i + 5) + x(i + 4) + + x(i + 3) + x(i + 2) + x(i + 1) + x(i)) mod 2 |
| 361 | x(i + 7) = (x(i + 3) + x(i + 2) + x(i + 1) + x(i)) mod 2 |
| 217 | x(i + 7) = (x(i + 6) + x(i + 5) + x(i + 4) + x(i)) mod 2 |
| 277 | x(i + 7) = (x(i + 6) + x(i + 5) + + x(i + 4) + x(i + 3) + x(i + 2) + x(i)) mod 2 |
| 323 | x(i + 7) = (x(i + 6) + x(i + 3) + x(i + 1) + x(i)) mod 2 |
| 203 | x(i + 7) = (x(i + 6) + x(i)) mod 2 |
| 253 | x(i + 7) = (x(i + 6) + x(i + 4) + x(i + 2) + x(i)) mod 2 |
| 271 | x(i + 7) = (x(i + 4) + x(i + 3) + x(i + 2) + x(i)) mod 2 |
| 367 | x(i + 7) = (x(i + 6) + x(i + 5) + + x(i + 3) + x(i + 2) + x(i + 1) + x(i)) mod 2 |
| 345 | x(i + 7) = (x(i + 5) + x(i + 2) + x(i + 1) + x(i)) mod 2 |
| 221 | x(i + 7) = (x(i + 3) + x(i)) mod 2 |

As shown in FIG. 3, every line connects a preferred pair. For example, {x, x[q]} is a preferred pair for ten values of q, namely 3, 5, 9, 11, 13, 15, 23, 27, 29, and 43 with the corresponding generator polynomials 217, 235, 277, 325, 203, 357, 301, 323, 253, 247 in octal representation. The lines emanating from the vertex marked x indicate the ten preferred pairs that contain x (e.g., there are similar sets from other vertices that are not shown). Thus, every set of six consecutive vertices around the perimeter of the polygon is a maximal connected set. For example, {211, 247, 356, 235, 325, 301} is a maximal connected set of polynomials, {271, 367, 345, 221, 361, 375}, is a maximal connected set of polynomials, {221, 345, 367, 271, 253, 203} is a maximal connected set of polynomials, and so on. In sum, there are eighteen maximal connected sets depicted in FIG. 3, where each m-sequence belongs to six of the maximal connected sets of polynomials.

For N=127, and n=7, a maximal connected set of m-sequences of length/period 127 contains six sequences and has peak periodic cross-correlation magnitude, θ_{dd′}=17/127. The peak periodic cross-correlation magnitude for any set of seven or more m-sequences of length 127 may be a relatively large value of θ_{dd′}-41/127, and the peak periodic auto-correlation magnitude of a length—127 m-sequence for a non-zero shift k is θ_{dd}=1/127.

As an example, a first PSS (e.g., for a first RAT) is based on a first m-sequence, and a second PSS (e.g., for a second RAT) is based on a second m-sequence, where the first m-sequence and the second m-sequence are a preferred pair of m-sequences. As another example, the first m-sequence and the second m-sequence are elements of at least one connected set of m-sequences and a maximal connected set of m-sequences.

In some cases, the first m-sequence is generated from a first polynomial of a preferred pair of polynomials and the second m-sequence is generated from a second polynomial of the preferred pair of polynomials. For example, the first polynomial is [211] in octal representation, and the [301], the primitive (over GF(2)) polynomial g(X)=X⁷+X⁶+1 with coefficients vector [g₇ g₆ g₅ g₄ g₃ g₂ g₁ 90][1 1 0 0 0 0 0 1](g₀ on right to gᵣ on left)) in octal representation, are a preferred pair of polynomials (e.g., as shown in FIG. 3). The first polynomial and the second polynomial (e.g., or the first m-sequence generator and the second m-sequence generator) may correspond to the linear feedback shift-register 210 with only two feedback connections.

The first m-sequence may be generated from the first polynomial of [211](e.g., same as the m-sequence used for the PSS of the legacy RAT) and gives the recursive definition of the subsequent sequence elements as:

$$x ( i + 7 ) = ( x ( i + 4 ) + x ( i ) ) mod 2$$

with a first non-zero initial condition
[x(6) x(5) x(4) x(3) x(2) x(1) x(0)]. The first PSS may be based on a first cyclic shift from a first set of cyclic shifts (e.g., [0, 43, 86]) of the first m-sequence. The first cyclic shift value may be based on the value of N_{ID}⁽²⁾ (e.g., a first portion a first physical layer cell identity, and N_{ID}⁽²⁾ ∈{0, 1, 2}). In one example, the first non-zero initial condition is [x(6) x(5) x(4) x(3) x(2) x(1) x(0)]=[1 1 1 0 1 1 0].

The second m-sequence generated from the second polynomial of [301] gives the recursive definition of the subsequent sequence elements as:

$$x ( i + 7 ) = ( x ( i + 1 ) + x ( i ) ) mod 2$$

with a second non-zero initial condition
[x(6) x(5) x(4) x(3) x(2) x(1) x(0)]. The second non-zero initial condition may be the same or different than the first non-zero initial condition. The second PSS may be based on a second cyclic shift from a second set of cyclic shifts. The second cyclic shift value may be based on the value of N_{ID}⁽²⁾ (e.g., a first portion a second physical layer cell identity, and N_{ID}⁽²⁾∈{0, 1, 2}). The second set of cyclic shifts may be the same or different than the first set of cyclic shifts. In some cases, at least one element of the second set of cyclic shifts is different than the first set of cyclic shifts. In some cases, the spacing or the difference between adjacent cyclic shift values may not be same.

The first PSS may be based on the sequence d_{PSS}(n) and can be defined by:

$${d}_{P S S} ( n ) = 1 - 2 x ( m )$$

$$m = ( n + 43 {N}_{ID}^{( 2 )} ) mod 127$$

$$0 \leq n < 127$$

where x(n) is the first m-sequence generated from the first polynomial of [211], and N_{ID}⁽²⁾∈{0, 1, 2}. The second PSS may be based on the second sequence d′_{PSS}(n) and can be defined by:

$${d}_{PSS}^{′} ( n ) = 1 - 2 x ( m )$$

$$m = ( n + s ( {N}_{ID}^{( 2 )} ) ) mod 127$$

$$0 \leq n < 127$$

where x(m) is the second m-sequence generated from the second polynomial of [301], and [s(0) s(1) s(2)] are the second set of cyclic shifts for N_{ID}⁽²⁾∈{0, 1, 2}. In one example, the second non-zero initial condition is
[x(6) x(5) x(4) x(3) x(2) x(1) x(0)]=[1 1 0 0 0 1 1], and the second set of cyclic shifts is [s(0), s(1), s(2)]=[0, 41, 84].

In some examples, a different second non-zero initial condition and a different second set of cyclic shifts may be selected that generate the same second sequence d′_{PSS}(n). For example, the second non-zero initial condition may be the same as the first non-zero initial condition ([x(6) x(5) x(4) x(3) x(2) x(1) x(0)]=[301], and the second set of cyclic shifts [s(0), s(1), s(2)]=[9, 50, 93] generates the same second sequence d′_{PSS}(n).

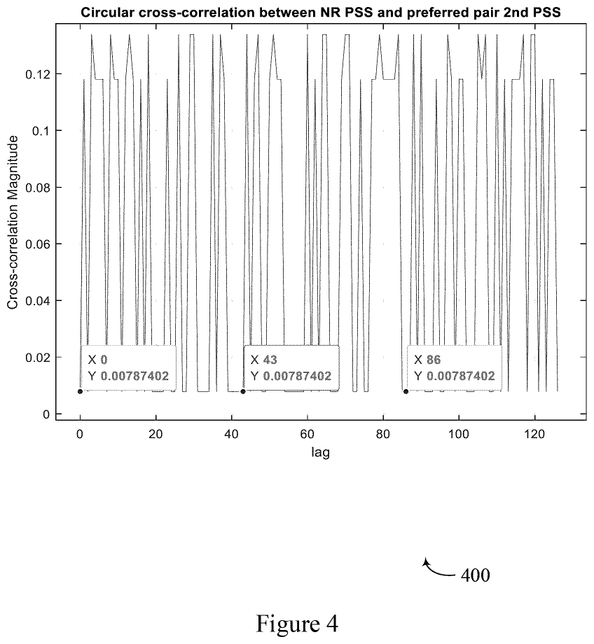

FIG. 4 illustrates an example graph 400 of cross-correlation magnitudes for m-sequences in accordance with aspects of the present disclosure. For example, the graph 400 depicts a periodic cross-correlation magnitude between the three cyclic shifts of the first m-sequence (e.g., used for the PSS of the legacy RAT) and the second m-sequence generated from the second polynomial of [301]. The cross-correlation values are depicted with the magnitude values θ_{dd′}=17/127, 1/127, 15/127.

The graph 400 illustrates a periodic cross-correlation magnitude of the three cyclic shifts of the first m-sequence. The second m-sequence is generated with the lowest value of θ_{dd′}=1/127 for the selected second non-zero initial condition and/or the second set of cyclic shifts. For example, the second non-zero initial condition and/or the second set of cyclic shifts are selected such that the periodic cross-correlation magnitude between the first m-sequence (with the first set of cyclic shifts) and the second m-sequence is the lowest value of the three-valued cross-correlation spectrum of 1/N, where Nis the length of the m-sequence.

In some cases, the SSS is a Gold sequence based on the first m-sequence and a second m-sequence. With the first PSS sequence based on the first m-sequence and the second PSS sequence based on the second m-sequence, a good (e.g., low) cross-correlation between the PSS and SSS sequences may be realized with a three-valued cross-correlation spectrum, as described herein, such as when the first m-sequence and a second m-sequence are preferred pairs of m-sequences and result in in PSS and SSS sequences being members of a same Gold code family.

In some examples, the second set of cyclic shifts (e.g., associated with a set of N_{ID}²)) of the second m-sequence (for the second PSS of the second RAT) may be a first set of cyclic shift (CS) values (e.g., [9, 50, 93]) for a first frequency band (e.g., spectrum sharing band that may at least partially shared with a first RAT), and may be a second set of CS values (e.g., [0, 43, 86]) of the second m-sequence for a second frequency band (e.g., second RAT, 6G specific band).

In some examples, the second non-zero initial condition of the second m-sequence (for the second PSS of the second RAT) may be a non-zero initial condition value, e.g.:
[x(6) x(5) x(4) x(3) x(2) x(1) x(0)]=[1 1 0 0 0 1 1] For a first frequency band (e.g., a spectrum sharing band that may at least partially shared with a first RAT), and may be a second non-zero initial condition value, e.g.:
[x(6) x(5) x(4) x(3) x(2) x(1) x(0)]=[1 1 1 0 1 1 0] of the second m-sequence for a second frequency band (e.g., second RAT, 6G specific band).

In some examples, a large number of PCIDs are associated with and/or utilized by a RAT (e.g., a new RAT), such as to simplify cell-planning and or to facilitate deployment with a large number of cells or TRPs (e.g., distributed multiple-input, multiple-output (MIMO), cell-free MIMO, dense deployments on nodes, and so on). For example, to support a large number of PCIDs (e.g., double the NR=2×1008=2016), the unique physical-layer cell identities may be given by:

$${N}_{ID}^{ce11} = 6 {N}_{ID}^{( 1 )} + {N}_{ID}^{( 2 )}$$

where N_{ID}⁽¹⁾∈{0, 1, . . . , 335} and N_{ID}⁽²⁾∈{0, 1, 2, 3, 4, 5}.

The PSS sequence may depend on the value of N_{ID}⁽²⁾ and may be based on a first m-sequence with a first set of cyclic shifts and a first non-zero initial condition for a first set of N_{ID}⁽²⁾ values, and a second m-sequence with a second set of cyclic shifts and a second non-zero initial condition for a second set of N_{ID}⁽²⁾ values. The second set of cyclic shifts may be the same or different than the first set of cyclic shifts. The second non-zero initial condition may be the same or different than the first non-zero initial condition.

In some examples, the first m-sequence is generated from a first polynomial of a preferred pair of polynomials, and the second m-sequence is generated from a second polynomial of the preferred pair of polynomials. For example, the first polynomial is [211] in octal representation, and the second polynomial is [301] in octal representation, are a preferred pair of polynomials (as shown in FIG. 3). In some cases, the first polynomial and the second polynomial (or the first m-sequence generator and the second m-sequence generator) correspond to the linear feedback shift-register 210, with only two feedback connections. In some cases, the first m-sequence and the second m-sequence are elements of a connected set of m-sequences and/r a maximal connected set of m-sequences.

In some cases, the equation for recursive definition of the subsequent sequence elements for the first m-sequence and the second m-sequence, and examples of the first set of cyclic shifts and a first non-zero initial condition, and a second m-sequence with a second set of cyclic shifts and a second non-zero initial condition may be as described herein.

In some examples, the PSS is based on the sequence d_{PSS}(n) and can be defined by:

$${d}_{PSS} ( n ) = 1 - 2 {x}_{1} ( m ) for {N}_{ID}^{( 2 )} ∈ \{ 0 , 1 , 2 \}$$

$$m = ( n + {s}_{1} ( {N}_{ID}^{( 2 )} ) ) mod 127$$

$$0 \leq n < 127$$

where x₁(n) is the first m-sequence generated e.g., from the first polynomial of [211] with a first non-zero initial condition
[x(6) x(5) x(4) x(3) x(2) x(1) x(0)], and [s₁(0) s₁(1) s₁(2) ] are the first set of cyclic shifts, and

$${d}_{PSS} ( n ) = 1 - 2 {x}_{2} ( m ) for {N}_{ID}^{( 2 )} ∈ \{ 3 , 4 , 5 \}$$

$$m = ( n + {s}_{2} ( {N}_{ID}^{( 2 )} - 3 ) ) mod 127$$

$$0 \leq n < 127$$

where x₂(n) is the second m-sequence generated e.g., from the second polynomial of [301], and [s₂(0) s₂(1) s₂(2) ] are the second set of cyclic shifts.

In some cases, the first non-zero initial condition is:
[x(6) x(5) x(4) x(3) x(2) x(1) x(0)]=[1 1 1 0 1 1 0], and first set of cyclic shifts [s₁(0) s₁(1) s₁(2)]=[0 43 86].

In some examples, the second non-zero initial condition is:
[x(6) x(5) x(4) x(3) x(2) x(1) x(0)]=[1 1 0 0 0 1 1], and the second set of cyclic shifts [s(0), s(1), s(2)]=[0, 41, 84].

In some examples, the second non-zero initial condition is the same as the first non-zero initial condition ([x(6) x(5) x(4) x(3) x(2) x(1) x(0)]=[1 1 1 0 1 1 0]), and the second set of cyclic shifts [s(0), s(1), s(2)]=[9, 50, 93].

In some cases, to enable support of large number of PCID, the PSS signal may be based on a first m-sequence with a first set of cyclic shifts depending on the value of N_{ID}⁽²⁾ and a first non-zero initial condition. In some examples, the PSS is based on the sequence d_{PSS}(n) and can be defined by:

$${d}_{PSS} ( n ) = 1 - 2 x ( m ) for {N}_{ID}^{( 2 )} ∈ \{ 0 , 1 , 2 , 3 , 4 , 5 \}$$

$$m = ( n + s ( {N}_{ID}^{( 2 )} ) ) mod 127$$

$$0 \leq n < 127$$

where x₁(n) is the first m-sequence generated e.g., from the first polynomial of [211] with a first non-zero initial condition
[x(6) x(5) x(4) x(3) x(2) x(1) x(0)], and
[s(0) s(1) s(2) s(4) s(5) s(6)] are the first set of cyclic shifts. As one example, [s(0) s(1) s(2) s(4) s(5) s(6)]=[0 22 43 65 86 108].

As another example,

$$s ( {N}_{ID}^{( 2 )} ) = 43 ( {N}_{ID}^{( 2 )} mod 3 ) + 22 \vert \frac{{N}_{ID}^{( 2 )}}{3} \vert$$

where a floor function └x┘, also called the greatest integer function or integer value, gives the largest integer less than or equal to x. In some cases, a larger separation between consecutive cyclic shift values may improve the carrier frequency synchronization performance of a node receiving the synchronization signal.

### Examples of an SSS Design

As described herein, the SSS of a first RAT (e.g., a legacy RAT) may be a Gold sequence and constructed and/or determined from two m-sequences x₀(n) and x₁(n) of length N=2^{r-1} generated by means of a generator polynomial of degree r=7 using the first m-sequence x₀(n) primitive (over GF(2)) polynomial g(X)=X⁷+X³+1 with a coefficients vector [g₇ g₆ 95 g₄ g₃ g₂ g₁ 90][1 0 0 0 1 0 0 1](g₀ on right to gᵣ on left), which is [211] in octal representation, and the second m-sequence x₁(n) primitive (over GF(2)) polynomial g(X)=X⁷+X⁶+1, with a coefficients vector [g₇ g₆ g₅ g₄ g₃ g₂ g₁ 90][1 1 0 0 0 0 0 1](g₀ on right to gᵣ on left), which is [301] in octal representation.

The initial condition for the first m-sequence x₀(n) and second m-sequence x₁(n) is:
[x₀(6) x₀(5) x₀(4) x₀(3) x₀(2) x₀(1) x₀(0)]=[0 0 0 0 0 0 1]
[x₁(6) x₁(5) x₁(4) x₁(3) x₁(2) x₁(1) x₁(0)]=[0 0 0 0 0 0 1]
   with the recursive definition of the subsequent sequence elements described as:

$${x}_{0} ( i + 7 ) = ( {x}_{0} ( i + 4 ) + {x}_{0} ( i ) ) mod 2$$

$${x}_{1} ( i + 7 ) = ( {x}_{1} ( i + 1 ) + {x}_{1} ( i ) ) mod 2$$

The index of the PSS sequence (N_{ID}⁽²⁾∈{0, 1, 2}) may be used in generation of nine cyclic shifts for the first m-sequence. The sequence d_{SSS}(n) (e.g., a Gold sequence) for the SSS may be defined by (where m₀ and m₁ are cyclic shifts for the first m-sequence and second m-sequence, respectively):

$${d}_{S S S} ( n ) = [ 1 - 2 {x}_{0} ( ( n + {m}_{0} ) mod 127 ) ] [ 1 - 2 {x}_{1} ( ( n + {m}_{1} ) mod 127 ) ]$$

$${m}_{0} = 15 ⌊ \frac{{N}_{ID}^{( 1 )}}{112} ⌋ + 5 {N}_{ID}^{( 2 )}$$

$${m}_{1} = {N}_{ID}^{( 1 )} mod 112$$

$$0 \leq n < 127$$

For example, for a new RAT (e.g., a second RAT), the SSS (or SSS sequence) may be based on the same length—127 Gold-sequence as the SSS of the first RAT and the same first m-sequence (x₀(n), first generator polynomial of [211] in octal representation) and second m-sequence (x₁(n), second generator polynomial of [301] in octal representation), but with different cyclic shift values. The PSS of the second RAT is based on a length—127 m-sequence with three different cyclic shift values based on the value of N_{ID}⁽²⁾∈{0, 1, 2}. For example, the SSS first m-sequence x₀(n) cyclic shift values (m₀) of the second RAT may be based on an offset from the cyclic shifts on the first RAT (e.g., an offset of 63). The SSS second m-sequence x₁(n) cyclic shift values (m₁), are the same as the first RAT and based on the value of N_{ID}⁽¹⁾. The sequence d′_{SSS}(n) for the SSS of the second RAT can be defined by:

$${d}_{SSS}^{′} ( n ) = [ 1 - 2 {x}_{0} ( ( n + {m}_{0} ) mod 127 ) ] [ 1 - 2 {x}_{1} ( ( n + {m}_{1} ) mod 127 ) ]$$

$${m}_{0} = 15 ⌊ \frac{{N}_{ID}^{( 1 )}}{112} ⌋ + 5 {N}_{ID}^{( 2 )} + 63$$

$${m}_{1} = {N}_{ID}^{( 1 )} mod 112$$

$$0 \leq n < 127$$

In some examples, the PSS of the first RAT PSS and/or the PSS of the second RAT are based on the length—127 first m-sequence. In some cases, the PSS of the second RAT is the same as the PSS of the first RAT with the same cyclic shift values based on N_{ID}⁽²⁾. In some cases, the PSS pf the second RAT is based on the first m-sequence of the PSS of the first RAT, but with different cyclic shift values, as described herein. In some cases, the initial values and/or non-zero initial condition of the PSS of the first RAT and the PSS of the second RAT are the same.

The PSS of the first RAT may be based on the first m-sequence and the PSS of the second RAT may be based on the second m-sequence. The first m-sequence and the second m-sequence may be a preferred pair of m-sequences. For example, the first m-sequence and the second m-sequence are elements of at least one of a connected set of m-sequences and a maximal connected set of m-sequences.

In some examples, the SSS of the second RAT is a Gold sequence based on a third m-sequence and a fourth m-sequence, where the third m-sequence and the fourth m-sequence are a preferred pair of m-sequences. In some cases, the initial condition/values for the third m-sequence x₂ and the fourth m-sequence x₃ may be the same as the first m-sequence and the second m-sequence:
[x₂(6) x₂(5) x₂(4) x₂(3) x₂(2) x₂(1) x₂(0)]=[0 0 0 0 0 0 1]
[x₃(6) x₃(5) x₃(4) x₃(3) x₃(2) x₃(1) x₃(0)]=[0 0 0 0 0 0 1]

In some cases, the first m-sequence (e.g., of a first RAT), the second m-sequence (e.g., of the first RAT), the third m-sequence, and the fourth m-sequence are elements of at least one of a connected set of m-sequences and a maximal connected set of m-sequences. For example, the third m-sequence may be the same as the first m-sequence and generated from the third generator polynomial of [211], and the fourth m-sequence is generated from the fourth generator polynomial of [325]. As shown in FIG. 3, {21 1, 325, 301} are elements of a connected set of polynomials, where each pair of m-sequences is a preferred pair of m-sequences. The polynomials {211, 325, 301} are also elements of the maximal connected set of polynomials of {211, 247, 356, 235, 325, 301}. A reciprocal m-sequence may be generated by the reciprocal polynomial gᵣ(X)=X^{r}g(X−1), which is a reverse of the m-sequence generated by the polynomial g(X), except for a phase shift (e.g., a cyclic shift).

In some examples, the third m-sequence is a reciprocal m-sequence of the first m-sequence and/or a fourth m-sequence is a reciprocal m-sequence of the second m-sequence. For example, the third m-sequence may be generated from the third polynomial of [221], which is a reciprocal of the first m-sequence generated from the first polynomial of [211]. As another example, the fourth m-sequence may be generated from the fourth polynomial of [203], which is a reciprocal of the second m-sequence generated from the first polynomial of [301]. Thus, the third m-sequence and the fourth m-sequence are a preferred pair of m-sequences.

As described herein, a large number of PCIDs may be associated with and/or utilized by a RAT (e.g., a new RAT). For example, to support a large number of PCIDs (e.g., double the NR=2×1008=2016), the unique physical-layer cell identities may be given by:

$${N}_{ID}^{cell} = 6 {N}_{ID}^{( 1 )} + {N}_{ID}^{( 2 )}$$

where N_{ID}⁽¹⁾∈{0, 1, . . . , 335} and N_{ID}⁽²⁾∈{, 1, 2, 3, 4, 5}.

Thus, in some examples, the SSS (or SSS sequence) may be based on a length-127 Gold-sequence with the first m-sequence (x₀(n) (e.g., first generator polynomial of [211] in octal representation) and the second m-sequence x₁(n) (e.g., second generator polynomial of [301] in octal representation). The first m-sequence and the second m-sequence are a preferred pair of m-sequences. For example, the first m-sequence and the second m-sequence are elements of at least one of a connected set of m-sequences and a maximal connected set of m-sequences.

In some cases, the SSS first m-sequence x₀(n) cyclic shift values (m₀) are based on the value of N_{ID}² and N_{ID}⁽¹⁾, and the SSS second m-sequence x₁(n) cyclic shift values (m₁), are based on the value of N_{ID}⁽¹⁾. The sequence d_{SSS}(n) for the secondary synchronization signal can be defined by:

$${d}_{SSS} ( n ) = [ 1 - 2 {x}_{0} ( ( n + {m}_{0} ) mod 127 ) ] [ 1 - 2 {x}_{1} ( ( n + {m}_{1} ) mod 127 ) ]$$

$${m}_{0} = 30 ⌊ \frac{{N}_{ID}^{( 1 )}}{112} ⌋ + 5 {N}_{ID}^{( 2 )}$$

$${m}_{1} = {N}_{ID}^{( 1 )} mod 112$$

$$0 \leq n < 127$$

In some examples, the SSS first m-sequence x₀(n) cyclic shift values (m₀) may be given as:

$${m}_{0} = 15 ⌊ \frac{{N}_{ID}^{( 1 )}}{112} ⌋ + 5 {N}_{ID}^{( 2 )} + 45 ⌊ \frac{{N}_{ID}^{( 2 )}}{3} ⌋$$

In some examples, the SSS first m-sequence x₀(n) cyclic shift values (m₀) may be given as:

$${m}_{0} = 15 ⌊ \frac{{N}_{ID}^{( 1 )}}{112} ⌋ + 5 {N}_{ID}^{( 2 )} + 63 ⌊ \frac{{N}_{ID}^{( 2 )}}{3} ⌋$$

In some cases, an initial condition for the first m-sequence x₀(n) and second m-sequence x₁(n) is:
[x₀(6) x₀(5) x₀(4) x₀(3) x₀(2) x₀(1) x₀(0)]=[0 0 0 0 0 0 1]
[x₁(6) x₁(5) x₁(4) x₁(3) x₁(2) x₁(1) x₁(0)]=[0 0 0 0 0 0 1]
   with the recursive definition of the subsequent sequence elements described as,

$${x}_{0} ( i + 7 ) = ( {x}_{0} ( i + 4 ) + {x}_{0} ( i ) ) mod 2$$

$${x}_{1} ( i + 7 ) = ( {x}_{1} ( i + 1 ) + {x}_{1} ( i ) ) mod 2$$

The PSS may be based on a length—127 first m-sequence with six different cyclic shift values based on the value of N_{ID}⁽²⁾∈{0, 1, 2, 3, 4, 5}. The PSS signal may depend on the value of N_{ID}⁽²⁾ and may be based on the first m-sequence with a first set of cyclic shifts and a first non-zero initial condition for a first set of N_{ID}⁽²⁾ values and the second m-sequence with a second set of cyclic shifts and a second non-zero initial condition for a second set of N_{ID}⁽²⁾ values. The second set of cyclic shifts may be the same or different than the first set of cyclic shifts. The second non-zero initial condition may be the same or different than the first non-zero initial condition.

In some examples, the SSS (or SSS sequence) may be based on a first m-sequence x₀(n) with a first set of cyclic shift values (m₀) and a second m-sequence x₁(n) with a second set of cyclic shift values (m′₁) for a first set of N_{ID}⁽²⁾ values and a third m-sequence x₂(n) with a third set of cyclic shift values (m′₀) and a fourth m-sequence x₃(n) with a fourth set of cyclic shift values (m′₁) for a second set of N_{ID}⁽²⁾ values. The third set of cyclic shifts may be the same or different than the first set of cyclic shifts, and the fourth set of cyclic shifts may be the same or different than the third set of cyclic shifts. The third/fourth non-zero initial condition/values may be the same or different than the first/second non-zero initial condition. The first m-sequence and the second m-sequence are a first preferred pair of m-sequences and the third m-sequence and the fourth m-sequence are a second preferred pair of m-sequences.

In some cases, the first m-sequence (e.g., of a first RAT), a second m-sequence (e.g., of the first RAT), the third m-sequence, and the fourth m-sequence are elements of at least one of a connected set of m-sequences and a maximal connected set of m-sequences. The third m-sequence may be the same as the first m-sequence and generated from the third generator polynomial of [211], and the fourth m-sequence is generated from the fourth generator polynomial of [325]. In some cases, the third m-sequence is a reciprocal m-sequence of the first m-sequence and/or the fourth m-sequence is a reciprocal m-sequence of the second m-sequence. For example, the third m-sequence is generated from the third polynomial of [221], which is a reciprocal of the first m-sequence generated from the first polynomial of [211]. As another example, the fourth m-sequence is generated from the fourth polynomial of [203], which is a reciprocal of the second m-sequence generated from the first polynomial of [301].

In some cases, to support a large number of PCIDs (e.g., 2016), the unique physical-layer cell identities may be given by:

$${N}_{ID}^{cell} = 3 {N}_{ID}^{( 1 )} + {N}_{ID}^{( 2 )}$$

where N_{ID}⁽¹⁾∈{0, 1, . . . , 671} and N_{ID}⁽²⁾∈{0, 1, 2}.

In some cases, the PSS is based on a length—127 m-sequence with six different cyclic shift values based on the value of N_{ID}⁽²⁾ ∈{0, 1, 2}. In some examples, the SSS (or SSS sequence) is based on a length—127 Gold-sequence with the first m-sequence (x₀(n) (e.g., a first generator polynomial of [211] in octal representation) and the second m-sequence x₁(n), (e.g., a second generator polynomial of [301] in octal representation). For example, the SSS first m-sequence x₀(n) cyclic shift values (m₀) are based on the value of N_{ID}⁽²⁾ and N_{ID}⁽¹⁾, and the SSS second m-sequence x₁(n) cyclic shift values (m₁), are based on the value of N_{ID}⁽²⁾. The sequence d_{SSS}(n) for the secondary synchronization signal may be defined by:

$${d}_{SSS} ( n ) = [ 1 - 2 {x}_{0} ( ( n + {m}_{0} ) mod 127 ) ] [ 1 - 2 {x}_{1} ( ( n + {m}_{1} ) mod 127 ) ]$$

$${m}_{0} = 15 ⌊ \frac{{N}_{ID}^{( 1 )}}{112} ⌋ + 5 {N}_{ID}^{( 2 )}$$

$${m}_{1} = {N}_{ID}^{( 1 )} mod 112$$

$$0 \leq n < 127$$

The initial condition for the first m-sequence x₀(n) and second m-sequence x₁(n) is:
[x₀(6) x₀(5) x₀(4) x₀(3) x₀(2) x₀(1) x₀(0)]=[0 0 0 0 0 0 1]
[x₁(6) x₁(5) x₁(4) x₁(3) x₁(2) x₁(1) x₁(0)]=[0 0 0 0 0 0 1]
with the Recursive Definition of the Subsequent Sequence Elements Described as,

$${x}_{0} ( i + 7 ) = ( {x}_{0} ( i + 4 ) + {x}_{0} ( i ) ) mod 2$$

$${x}_{1} ( i + 7 ) = ( {x}_{1} ( i + 1 ) + {x}_{1} ( i ) ) mod 2$$

Thus, in various examples, the wireless communication system 100 may facilitate, enable, support, and/or implement PSS and SSS sequence designs that exhibit low-cross correlation and can co-exist with PSS and SSS from different RATs on the same time-frequency resources.

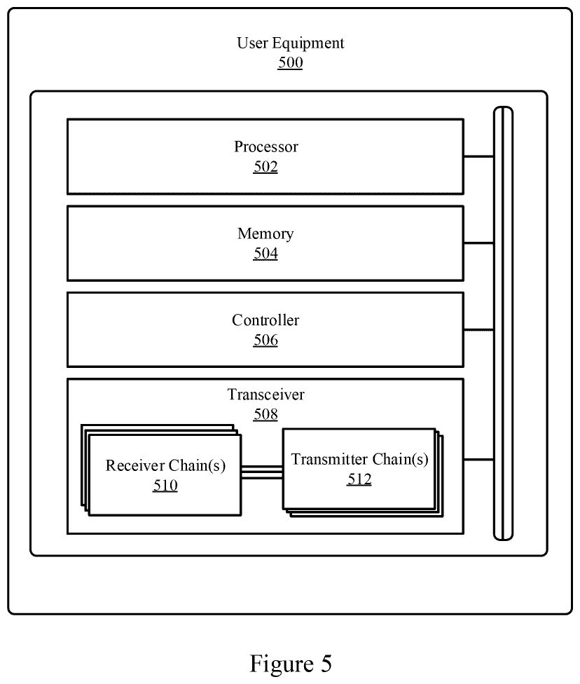

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to support a means for receiving, from a network node, a synchronization signal that includes a first PSS on a first set of resources or a second PSS on a second set of resources that partially overlap the first set of resources, wherein the first PSS is based on a first m-sequence and the second PSS is based on a second m-sequence that is a preferred pair with the first m-sequence, and communicating with the network node based on a PSS included in the synchronization signal.

As another example, the processor 502 may support wireless communication at the UE 500 in accordance with examples as disclosed herein. The UE 500 may be configured to support a means for receiving, from a network node, a synchronization signal that includes a first SSS on a first set of resources or a second SSS on a second set of resources that partially overlap the first set of resources, wherein the first SSS is based on a first m-sequence and a second m-sequence that is a first preferred pair with the first m-sequence, and the second SSS is based on a third m-sequence and a fourth m-sequence that is a second preferred pair with the third m-sequence, and communicating with the network node based on an SSS included in the synchronization signal.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

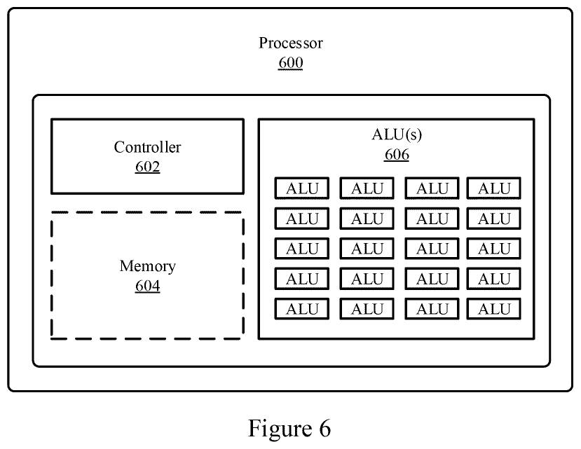

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support a means for receiving, from a network node, a synchronization signal that includes a first PSS on a first set of resources or a second PSS on a second set of resources that partially overlap the first set of resources, wherein the first PSS is based on a first m-sequence and the second PSS is based on a second m-sequence that is a preferred pair with the first m-sequence, and communicating with the network node based on a PSS included in the synchronization signal.

As another example, the processor 600 may be configured to or operable to support a means for receiving, from a network node, a synchronization signal that includes a first SSS on a first set of resources or a second SSS on a second set of resources that partially overlap the first set of resources, wherein the first SSS is based on a first m-sequence and a second m-sequence that is a first preferred pair with the first m-sequence, and the second SSS is based on a third m-sequence and a fourth m-sequence that is a second preferred pair with the third m-sequence, and communicating with the network node based on an SSS included in the synchronization signal.

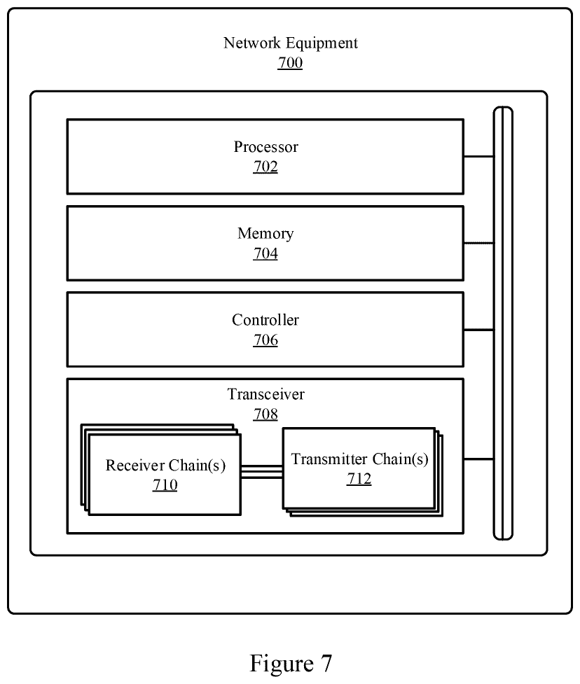

FIG. 7 illustrates an example of a NE 700 in accordance with aspects of the present disclosure. The NE 700 may include a processor 702, a memory 704, a controller 806, and a transceiver 708. The processor 702, the memory 704, the controller 806, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 806, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to support a means for transmitting, to a UE, a synchronization signal that includes a first PSS on a first set of resources or a second PSS on a second set of resources that partially overlap the first set of resources, wherein the first PSS is based on a first m-sequence and the second PSS is based on a second m-sequence that is a preferred pair with the first m-sequence, and receiving a transmission from the UE based on a PSS included in the synchronization signal.

As another example, the NE 700 may be configured to support a means for transmitting, to a UE, a synchronization signal that includes a first SSS on a first set of resources or a second SSS on a second set of resources that partially overlap the first set of resources, wherein the first SSS is based on a first m-sequence and a second m-sequence that is a first preferred pair with the first m-sequence and the second SSS is based on a third m-sequence and a fourth m-sequence that is a second preferred pair with the third m-sequence, and receiving a transmission from the UE based on an SSS included in the synchronization signal.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

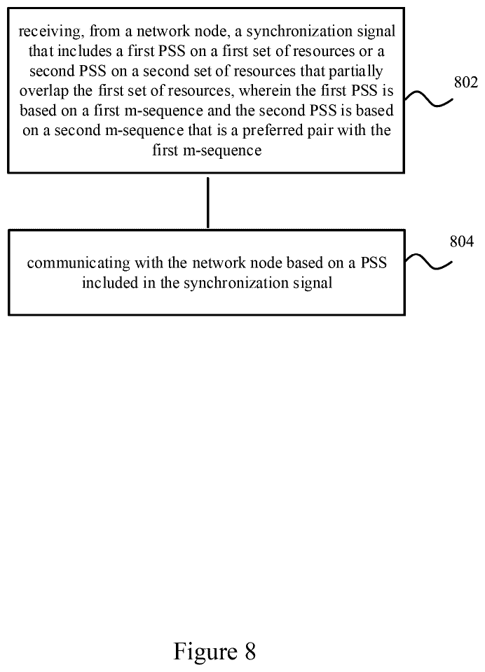

FIG. 8 illustrates a flowchart of a method in accordance with aspects of the present disclosure. The operations of the method may be implemented by a UE as described herein. In some implementations, the UE may execute a set of instructions to control the function elements of the UE to perform the described functions.

At 802, the method may include receiving, from a network node, a synchronization signal that includes a first PSS on a first set of resources or a second PSS on a second set of resources that partially overlap the first set of resources, wherein the first PSS is based on a first m-sequence and the second PSS is based on a second m-sequence that is a preferred pair with the first m-sequence. The operations of 802 may be performed in accordance with examples as described herein. In some implementations, aspects of the operations of 802 may be performed by a UE as described with reference to FIG. 5.

At 804, the method may include communicating with the network node based on a PSS included in the synchronization signal. The operations of 804 may be performed in accordance with examples as described herein. In some implementations, aspects of the operations of 804 may be performed a UE as described with reference to FIG. 5.

It should be noted that the method described herein describes a possible implementation, and that the operations and the steps may be rearranged or otherwise modified and that other implementations are possible.

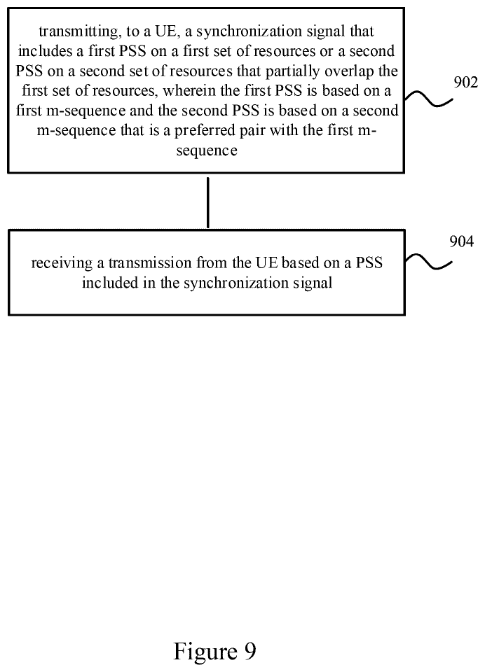

FIG. 9 illustrates a flowchart of a method in accordance with aspects of the present disclosure. The operations of the method may be implemented by an NE as described herein. In some implementations, the NE may execute a set of instructions to control the function elements of the NE to perform the described functions.

At 902, the method may include transmitting, to a UE, a synchronization signal that includes a first PSS on a first set of resources or a second PSS on a second set of resources that partially overlap the first set of resources, wherein the first PSS is based on a first m-sequence and the second PSS is based on a second m-sequence that is a preferred pair with the first m-sequence. The operations of 902 may be performed in accordance with examples as described herein. In some implementations, aspects of the operations of 902 may be performed by an NE as described with reference to FIG. 7.

At 904, the method may include receiving a transmission from the UE based on a PSS included in the synchronization signal. The operations of 904 may be performed in accordance with examples as described herein. In some implementations, aspects of the operations of 904 may be performed by an NE as described with reference to FIG. 7.

It should be noted that the method described herein describes a possible implementation, and that the operations and the steps may be rearranged or otherwise modified and that other implementations are possible.

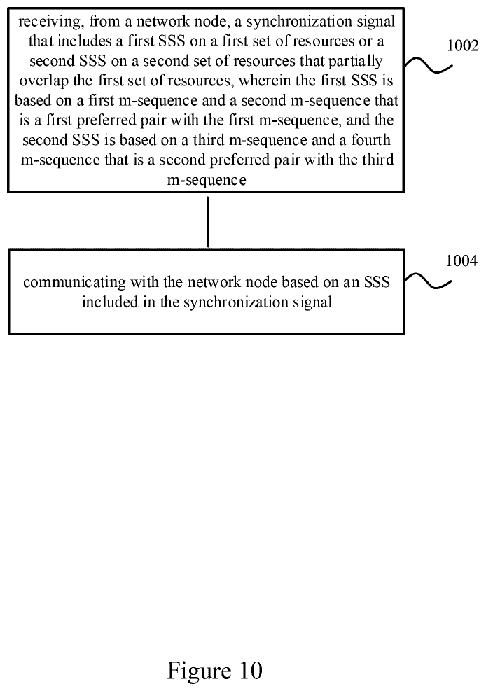

FIG. 10 illustrates a flowchart of a method in accordance with aspects of the present disclosure. The operations of the method may be implemented by a UE as described herein. In some implementations, the UE may execute a set of instructions to control the function elements of the UE to perform the described functions.

At 1002, the method may include receiving, from a network node, a synchronization signal that includes a first SSS on a first set of resources or a second SSS on a second set of resources that partially overlap the first set of resources, wherein the first SSS is based on a first m-sequence and a second m-sequence that is a first preferred pair with the first m-sequence, and the second SSS is based on a third m-sequence and a fourth m-sequence that is a second preferred pair with the third m-sequence. The operations of 1002 may be performed in accordance with examples as described herein. In some implementations, aspects of the operations of 1002 may be performed by a UE as described with reference to FIG. 5.

At 1004, the method may include communicating with the network node based on an SSS included in the synchronization signal. The operations of 1004 may be performed in accordance with examples as described herein. In some implementations, aspects of the operations of 1004 may be performed by a UE as described with reference to FIG. 5.

It should be noted that the method described herein describes a possible implementation, and that the operations and the steps may be rearranged or otherwise modified and that other implementations are possible.

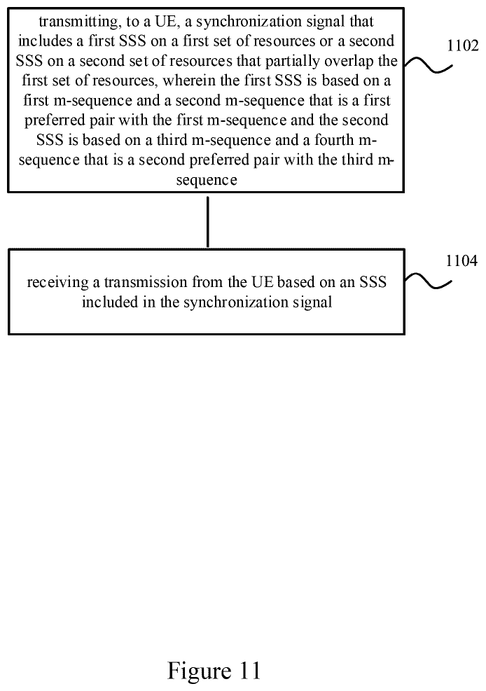

FIG. 11 illustrates a flowchart of a method in accordance with aspects of the present disclosure. The operations of the method may be implemented by an NE as described herein. In some implementations, the NE may execute a set of instructions to control the function elements of the NE to perform the described functions.

At 1102, the method may include transmitting, to a UE, a synchronization signal that includes a first SSS on a first set of resources or a second SSS on a second set of resources that partially overlap the first set of resources, wherein the first SSS is based on a first m-sequence and a second m-sequence that is a first preferred pair with the first m-sequence and the second SSS is based on a third m-sequence and a fourth m-sequence that is a second preferred pair with the third m-sequence. The operations of 1102 may be performed in accordance with examples as described herein. In some implementations, aspects of the operations of 1102 may be performed by an NE as described with reference to FIG. 7.

At 1104, the method may include receiving a transmission from the UE based on an SSS included in the synchronization signal. The operations of 1104 may be performed in accordance with examples as described herein. In some implementations, aspects of the operations of 1104 may be performed by an NE as described with reference to FIG. 7.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a network node, a synchronization signal that includes a first primary synchronization signal (PSS) on a first set of resources or a second PSS on a second set of resources that partially overlap the first set of resources,
wherein the first PSS is based on a first m-sequence and the second PSS is based on a second m-sequence that is a preferred pair with the first m-sequence; and
communicate with the network node based on a PSS included in the synchronization signal.

2. The UE of claim 1, wherein the first PSS is associated with a first radio access technology (RAT) and the second PSS is associated with a second RAT, and wherein the at least one processor is further configured to cause the UE to:
determine whether the synchronization signal is received from the first RAT or the second RAT based on the PSS included in the synchronization signal; and
communicate via a RAT associated with the PSS included in the synchronization signal.

3. The UE of claim 2, wherein a secondary synchronization signal (SSS) is associated with the first RAT based on the first m-sequence and the second m-sequence.

4. The UE of claim 1, wherein the first PSS is located in a first predefined synchronization signal raster in a frequency domain in a frequency band and the second PSS is located in a second predefined synchronization signal raster, different that the first predefined synchronization signal raster, in the frequency domain in the frequency band.

5. The UE of claim 1, wherein the at least one processor is further configured to cause the UE to:
determine at least a portion of a physical layer cell identity for the network node based on the determined PSS; and
communicate with the network node based on the portion of the physical layer cell identity.

6. The UE of claim 1, wherein the first m-sequence and the second m-sequence are elements of a maximal connected set of m-sequences having lengths equal to a length of the first m-sequence.

7. The UE of claim 1, wherein the first PSS is based on a first set of cyclic shifts of the first m-sequence and the second PSS is based on a second set of cyclic shifts of the second m-sequence.

8. The UE of claim 1, wherein the first m-sequence is based on first non-zero initial values of a first linear feedback shift register generator and the second m-sequence is based on second non-zero initial values of a second linear feedback shift register generator.

9. The UE of claim 1, wherein a first physical broadcast channel (PBCH) is associated with the first PSS and a second PBCH is associated with the second PSS, wherein the second PBCH has a different size, fields, field values, or time-frequency values than the first PBCH, and wherein the at least one processor is further configured to cause the UE to:
receive the first PBCH or the second PBCH based on the PSS included in the synchronization signal.

10. A network node for wireless communication, comprising:
at least one memory; and
at least one processor coupled with the at least one memory and configured to cause the network to:
transmit, to a user equipment (UE), a synchronization signal that includes a first primary synchronization signal (PSS) on a first set of resources or a second PSS on a second set of resources that partially overlap the first set of resources,
wherein the first PSS is based on a first m-sequence and the second PSS is based on a second m-sequence that is a preferred pair with the first m-sequence; and
receive a transmission from the UE based on a PSS included in the synchronization signal.

11. A user equipment (UE) for wireless communication, comprising:
at least one memory; and
at least one processor coupled with the at least one memory and configured to cause the UE to:
receive, from a network node, a synchronization signal that includes a first secondary synchronization signal (SSS) on a first set of resources or a second SSS on a second set of resources that partially overlap the first set of resources, wherein:
the first SSS is based on a first m-sequence and a second m-sequence that is a first preferred pair with the first m-sequence, and
the second SSS is based on a third m-sequence and a fourth m-sequence that is a second preferred pair with the third m-sequence; and
communicate with the network node based on an SSS included in the synchronization signal.

12. The UE of claim 11, wherein the first preferred pair and the second preferred pair are elements of a connected set of m-sequences having a shared length with a length of the first m-sequence.

13. The UE of claim 11, wherein the third m-sequence is a reciprocal of the first m-sequence, or the fourth m-sequence is a reciprocal of the second m-sequence.

14. The UE of claim 11, wherein the first m-sequence is a same m-sequence as the third m-sequence, and wherein a first set of cyclic shifts of the first m-sequence is different than a third set of cyclic shifts of the third m-sequence, and wherein the first set of cyclic shifts and the third set of cyclic shifts are based on a first portion and a second portion of a physical layer cell identity of the network node, and wherein the at least one processor is further configured to cause the UE to:
determine the first portion or the second portion of the physical layer cell identity of the network node based on the SSS included in the synchronization signal; and
communicate with the network node based on the first portion or the second portion of the physical layer cell identity.

15. The UE of claim 11, wherein a second set of cyclic shifts of the second m-sequence is a same set as a fourth set of cyclic shifts of the fourth m-sequence, and wherein the second set of cyclic shifts and the fourth set of cyclic shifts are based on a first portion of a physical layer cell identity of the network node.

16. The UE of claim 11, wherein the first SSS is associated with a first radio access technology (RAT) and the second SSS is associated with a second RAT, and wherein the at least one processor is further configured to cause the UE to:
determine whether the synchronization signal is received from the first RAT or the second RAT based on the SSS included in the synchronization signal; and
communicate via a RAT associated with the SSS included in the synchronization signal.

17. The UE of claim 16, wherein a first primary synchronization signal (PSS) is associated with the first RAT based on the first m-sequence and a second PSS is associated with the second RAT based on the second m-sequence.

18. The UE of claim 11, wherein the first SSS is located in a first predefined synchronization signal raster in a frequency domain in a frequency band and the second SSS is located in a second predefined synchronization signal raster, different that the first predefined synchronization signal raster, in the frequency domain in the frequency band.

19. The UE of claim 11, wherein a first physical broadcast channel (PBCH) is associated with the first SSS and a second PBCH is associated with the second SSS, wherein the second PBCH has a different size, fields, field values, or time-frequency values than then first PBCH, and wherein the at least one processor is further configured to cause the UE to:
receive the first PBCH or the second PBCH based on the SSS included in the synchronization signal.

20. A network node for wireless communication, comprising:
at least one memory; and
at least one processor coupled with the at least one memory and configured to cause the network node to:
transmit, to a user equipment (UE), a synchronization signal that includes a first secondary synchronization signal (SSS) on a first set of resources or a second SSS on a second set of resources that partially overlap the first set of resources, wherein:
the first SSS is based on a first m-sequence and a second m-sequence that is a first preferred pair with the first m-sequence, and
the second SSS is based on a third m-sequence and a fourth m-sequence that is a second preferred pair with the third m-sequence; and
receive a transmission from the UE based on an SSS included in the synchronization signal.
